(19) United States
(12) Patent Application Publication
(10) Pub. No.: US 2013/0084352 A1
(43) Pub. Date: Apr. 4, 2013

(54) MOLD HAVING RELEASE LAYER FOR IMPRINTING, METHOD FOR PRODUCING MOLD HAVING RELEASE LAYER FOR IMPRINTING, AND METHOD FOR PRODUCING COPY MOLD

(71) Applicants: Kota Suzuki, Shinjuku-ku (JP); Hideo Kobayashi, Shinjuku-ku (JP)

(72) Inventors: Kota Suzuki, Shinjuku-ku (JP); Hideo Kobayashi, Shinjuku-ku (JP)

(73) Assignee: HOYA CORPORATION, Shinjuku-ku, Tokyo (JP)

(21) Appl. No.: 13/638,493

(22) PCT Filed: Mar. 29, 2011
(86) PCT No.: PCT/JP2011/057762

§ 371 Date: Dec. 5, 2012

(30) Foreign Application Priority Data
Mar. 30, 2010 (JP) 2010-079288
Aug. 24, 2010 (JP) 2010-187569
Mar. 28, 2011 (JP) 2011-069290

(51) Int. Cl. B29C 59/00

(52) U.S. Cl. CPC B29C 59/002
USPC 425/385; 427/444; 216/41

(57) ABSTRACT

Provided is a mold having a release layer, in which the release layer is disposed in the mold which transfers a specific uneven pattern onto a molding material to be patterned by means of an imprinting method, wherein the main chain of the molecular chains of a compound contained in the release layer contains a fluorocarbons, the molecular chains of the compound have at least two adsorption functional groups that are adsorbed or bonded to the mold, the bonding energy in the adsorption functional groups that becomes the source of adsorption or bonding of the adsorption functional groups to the mold is greater than the bonding energy between one adsorption functional group and another adsorption functional group in the molecular chains of the compound, and the surface free energy of the release layer is optimized by means of heating.

### TECHNICAL FIELD

The present invention relates to a mold having a release layer for imprinting, a method for producing the mold having the release layer for imprinting, and a method for producing a copy mold.

### BACKGROUND ART

Conventionally, regarding a magnetic medium used for a hard disc and the like, there has been used a method in which magnetic particles are made into infinitesimals, the width of a magnetic head is minimized, and the width between data tracks on which information is recorded is narrowed, so as to achieve a high recording density.

Meanwhile, the density of the magnetic medium has been further increased and the magnetical influence between the adjacent recording tracks or recording bits is no longer ignorable. Thus, the conventional technique is facing the limit of densification.

In recent years, a magnetic medium called a patterned medium has been proposed. In the patterned medium, the adjacent recording tracks or recording bits are magnetically separated to each other with a trench or a card band made of a non-magnetic material to reduce the magnetical interference for improving the quality of signals, and achieving a higher recording density.

As a technique for mass-producing the patterned medium, imprint technology (or nanoimprint technology) is known. In the imprint technology, a fine uneven pattern (also referred to as pattern) of a master mold (also referred to as original) or a copy mold (also referred to as working replica) reproduced by single or plural times of transferring using the master mold as an original pattern, is transferred onto a transfer target substrate (magnetic medium herein). Thus, the patterned medium is produced. The imprint technology is a technique of performing transferring of a pattern formed on the master mold onto a transfer target body once or for plural times to reproduce the pattern on a final transfer target body (product) for mass-production.

Various techniques for preparing the master mold have been known. In particular, a technique has been known in which a substrate itself is etched to have a prescribed pattern and thus to be used as the mold (see, for example patent document 1).

The master mold provided with the fine pattern itself is not generally used as the mold for imprinting. What is used instead is a copy mold of a secondary mold reproduced by transferring the pattern on the master mold (primary mold) onto another transfer target substrate to form the pattern, a third mold reproduced by transferring the pattern on the secondary mold onto a yet another transfer target substrate to form the pattern, or a mold reproduced thereafter.

Even when these copy molds are deformed, damaged, or contaminated, the copy molds can be reproduced as long as the master mold is unharmed.

For example, to actually mass-produce the patterned medium, a plurality of imprint apparatuses are installed in parallel and operated. Accordingly, for the plurality of imprint apparatuses, a plurality of copy molds provided with the same prescribed fine pattern need to be produced and prepared. To produce the plurality of copy molds, the following steps needs to be carried out. Specifically, first, pattern transfer is carried out by pressing a master mold (or a copy mold serving as an original mold, such molds are hereinafter simply referred to as mold) against a molding material to be patterned (resist layer, or simply referred to as resist) on the transfer target substrate as described above. Then the mold is released from the resist layer, that is, the transfer target substrate. Furthermore, a large number of copy molds (working replicas) need to be produced by repeating the above described steps.

The following procedure is known for smoothly releasing the mold from the resist layer, that is, the transfer target substrate. Specifically, a mold surface is coated with a release agent compound in advance to form a release layer so that the pattern is transferred after mold releasability is provided.

By providing the mold with the release layer, the mold releasability between the release layer and the resist layer is improved, while maintaining a sufficient adhesion between the mold and the release layer. Thus, the mold can be released from the resist layer, that is, the transfer target substrate smoothly with a low releasing pressure. As a result, the damage on the mold, the damage (defect) on the transferred pattern, or the damage on the mold and the imprint apparatuses due to the releasing failure or defect can be reduced.

As a release agent compound, in patent document 2 for example, a technique is described in which a surface modifier including an organic silicone compound having a linear perfluoropolyether structure is used.

A silicone-based release agent compound is described in patent document 3. The silicone-based release agent compound has a basic structure of organo polysiloxane structure. Specifically, native or modified silicone oil, polysiloxane containing trimethyl siloxysilicate acid, silicone-based acryl resin, and the like are described as the compound.

### PRIOR ART DOCUMENTS

### Patent Documents

[Patent Document 1] Japanese Unexamined Patent Application Publication No. 2008-310944.
[Patent Document 2] Japanese Translation of PCT International Application Publication No. JP-Y-2008-537557.
[Patent Document 3] Japanese Unexamined Patent Application Publication No. 2010-006870.

### SUMMARY OF THE INVENTION

### Problems to be Solved by the Invention

As described in patent documents 2 and 3, a perfluoropolyether compound and a silicone-based compound are generally used for a release agent compound for nanoimprinting.

Generally, in the release agent compound, only one end group of a molecular chain of the release agent compound serves as a functional group for chemical bonding to a mold surface on which a release layer is to be provided. A modified silane group is often used as the functional group. The modified silane groups undergo dehydration synthesis on the mold surface through silanol bonding. Thus, the molecular chain of the release agent compound adsorbs to the mold surface.

A portion where no modified silane group is provided, that is, a portion of the perfluoroether group and silicone in the release agent compound reduces surface free energy of the release layer surface to be in contact with the material to be patterned. Accordingly, the mold can be released from the material to be patterned, that is, the transfer target substrate, smoothly at a low releasing pressure.

According to the release agent compound in which the modified silane group is provided on one end as described in patent documents 2 and 3, the modified silane group at the end of the molecular chain adheres to the substrate and a release layer having strong adhesion can be formed.

Unfortunately however, the modified silane group at the end in the release agent compound is highly reactive, and thus is likely to react easily with water in an atmosphere other than the mold surface. As a result, aggregation of the release agent compound itself might occur. When such an aggregation of the release agent compound occurs, the aggregated portion becomes a protruded or raised defect portion having much larger physical height and width than a peripheral non-aggregated portion. Thus, it becomes difficult to smoothly and repeatedly perform the releasing of the mold from the material to be patterned, that is, the transfer target substrate in the imprinting. In other words, it becomes difficult to transfer the pattern stably. This might eventually affect the quality of the final transfer target body (final product).

As described above, in the release agent compound in which the modified silane group is provided on one end as described in patent documents 2 and 3 for example, the modified silane group at the end of the molecular chain is adsorbed or bonded to the mold. As shown in FIG. 11 (a), since the modified silane group is provided only on one end of the molecular chain, it is considered that a direction from the modified silane group to the other end of the molecular chain, that is, the molecular chain as a whole, is oriented in the thickness direction of the release layer. Accordingly, the thickness of the release layer depends on the entire length of the molecular chain. This is expected to adversely affect the accuracy of the dimension and the shape of the pattern to be transferred on the resist layer in a case where the pattern on the mold to be transferred and formed on the resist layer has a size approximately equal to the entire length of the molecular chain. This is specifically described with the case where the size of the prescribed pattern is approximately equal to the length of the molecular chain of the release agent compound as shown in FIG. 11 (b). Here, in the release layer having the thickness approximately equal to the size of the pattern, the dimension and the shape of the prescribed pattern to be transferred onto the resist layer might by largely changed, and thus the transfer accuracy of the pattern might be degraded.

Moreover, the portion of the perfluoroether group and silicone in the release agent compound reduces the surface free energy of the release layer to come in direct contact with the resist layer as described above. Thus, the mold can be released from the resist layer, that is, the transfer target substrate smoothly at a low releasing pressure. Accordingly, it has been considered that the surface free energy of the release layer surface to come in contact with the material to be patterned is preferably low as much as possible to obtain favorable mold releasability.

Unfortunately, reducing the surface free energy of the release layer to come in direct contact with the molding material to be patterned might in turn cause a problem that the uneven pattern on the mold, the recesses in particular, is not favorably filled with the resist (see FIG. 10B related to a comparative example described below).

If the material to be patterned is not favorably filled in the recesses of the fine uneven pattern of the mold, the dimensions and the shape of the prescribed pattern are not accurately transferred onto the portions, and transfer failure occurs. As a result, the quality of the final transfer target body (product) might be affected.

In view of the situation described above, an object of the present invention is to provide a mold having a release layer for imprinting with which a material to be patterned is favorably filled in recesses of a pattern on the mold, and achieve highly accurate pattern transfer while having a sufficiently high mold releasability, and to provide a method for producing the same. The present invention also has an object of providing a method for producing a copy mold using the mold having the release layer for imprinting.

### Means of Solving the Problems

A first aspect of the present invention is a mold having a release layer, in which the release layer is disposed in the mold which transfers a prescribed uneven pattern onto a material to be patterned by means of an imprinting method. A main chain of a release agent compound (molecule) that forms the release layer includes fluorocarbon. The release agent compound includes at least two adsorption functional groups adsorbed or bonded to the mold. With respect to the adsorption functional groups, bonding energy between the adsorption functional groups and the mold is greater than bonding energy between one adsorption functional group and another adsorption functional group in a molecular chain of the release agent compound.

A second aspect of the present invention is that, in the invention according to the first aspect, the adsorption functional groups may each include a functional group capable of hydrogen bonding with the mold.

A third aspect of the present invention is that, in the invention according to the first or the second aspect, the adsorption functional groups may include any one of a hydroxyl group, a carboxyl group, an ester group, and any combination of these.

A forth aspect of the present invention is that, in the invention according to any one of the first to the third aspects, the adsorption functional groups may be respectively provided at both ends of the molecular chain of the release agent compound forming the release layer.

A fifth aspect of the present invention is that, in the invention according to any one of the first to the fourth aspects, the molecular chain of the release agent compound forming the release layer may include no side chain.

A sixth aspect of the present invention is that, in the invention according to any one of the first to the fifth aspects, the fluorocarbon may include one or a plurality of types of (CₘF₂ₘO)ₙ, where m is an integer satisfying 1≦m≦7 and n is an integer making a molecular weight of the (CₘF₂ₘO)ₙ equal to or larger than 500 and equal to or smaller than 6000.

A seventh aspect of the present invention is that, in the invention according to any one of the first to the sixth aspects, with respect to a relationship between a heating temperature for the release layer and surface free energy of the release layer, the release layer may include a region in which a value of the surface free energy is unchanged even when the heating temperature is changed and a region in which the value of the surface free energy increases or decreases as the heating temperature decreases or increases, and the release layer after the heating may include a region in which the value of the surface free energy increases as the heating temperature decreases.

An eighth aspect of the present invention is that, in the invention according to any one of the first to the seventh aspects, the mold may include a quartz substrate including an uneven pattern corresponding to the prescribed pattern.

A ninth aspect of the present invention is a mold having a release layer, in which the release layer is disposed in the mold which transfers a prescribed uneven pattern onto a material to be patterned by means of an imprinting method. A main chain in a molecular chain of a release agent compound that forms the release layer includes one or a plurality of types of (CₘF₂ₘO)ₙ, where m is an integer satisfying 1≦m≦7 and n is an integer making a molecular weight of the (CₘF₂ₘO)ₙ equal to or larger than 500 and equal to or smaller than 6000. The release agent compound includes at least two hydroxyl groups as adsorption functional groups for the mold, the hydroxyl groups being respectively provided at both ends of the release agent compound. In a relationship between a heating temperature for the release layer and surface free energy of the release layer, the release layer includes a region in which a value of the surface free energy is approximately unchanged even when the heating temperature is changed and a region in which the surface free energy increases and decreases as the heating temperature decreases and increases, and the release layer after the heating includes a region in which the value of the surface free energy increases as the heating temperature decreases.

A tenth aspect of the present invention is a method for producing the mold having the release layer according to the first aspect, and the method includes optimizing surface energy of the release layer by changing surface free energy of the release layer by means of heating after the mold is coated with a release agent compound.

An eleventh aspect of the present invention is that, in the invention according to the tenth aspect, the heating may be performed at a temperature equal to or higher than 25° C. and equal to or lower than 250° C.

A twelfth aspect of the present invention is that, the invention according to the tenth or the eleventh aspect may further include rinsing the release layer after the heating.

A thirteenth aspect of the present invention is a method for producing a copy mold from the mold having the release layer according to the first aspect, and the method includes: disposing the release layer in the mold; forming a hard mask layer on a substrate for producing the copy mold; forming a resist layer on the hard mask layer; transferring a pattern of the mold onto the resist layer; etching the hard mask layer using the resist layer as a mask, on which the pattern of the mold is transferred; and etching the substrate for producing the copy mold using the hard mask layer as a mask, which is etched using the resist layer as the mask.

### Effects of the Invention

According to the present invention, a sufficient mold releasability is provided at a lower releasing pressure and a material to be patterned is favorably filled in a pattern on a mold. Thus, the pattern can be accurately, stably, and repeatedly transferred.

### BRIEF DESCRIPTION OF THE DRAWINGS

FIG. 1 is a schematic diagram showing how adsorption functional groups in a molecular chain of a release agent compound according to the embodiment are adsorbed or bonded to a mold surface. (a) shows a case where hydroxyl groups are respectively provided at both ends of the molecular chain, (b) shows a case where hydroxyl groups are provided at portions other than the ends of the molecular chain, (c) shows how van der Waals force acts on the main chain, (d) shows a case where three hydroxyl groups are provided, and (e) shows a case where four hydroxyl groups are provided.

FIG. 2 is a schematic cross-sectional diagram for describing a mold having a release layer according to the embodiment.

FIG. 3 is a schematic cross-sectional diagram for describing steps for producing a copy mold using the mold having the release layer in FIG. 2.

FIG. 4 is a schematic diagram for describing behaviors of a molecular chain when a mold having a release layer according to the embodiment is heated.

FIG. 5 is a diagram showing measurement results of surface roughness of a mold having a release layer obtained from an example of the embodiment and a comparative example. (a) and (b) are bird eye views showing surface roughness of the mold having a release layer of the example, and (c) and (d) are bird eye views showing surface roughness of the comparative example.

FIG. 6 is a graph showing a relationship between a thickness of a release layer and the number of imprinting times for a mold having a release layer obtained from an example of the embodiment and a comparative example.

FIG. 7 is a graph showing examining results of a relationship between surface free energy of a release layer and the number of imprinting times for a mold having the release layer obtained from an example of the embodiment and the comparative example.

FIG. 8 is a graph showing a thickness of a release layer for imprinting of a mold having the release layer for imprinting obtained from an example of the embodiment and the comparative example.

FIG. 9 is a graph showing a relationship between a heating temperature and surface free energy in an example of the embodiment and the comparative example. (a) is a graph of the example of the embodiment and (b) is a graph of the comparative example.

FIG. 10 is photographs showing how a resist is filled in a pattern on a mold when the mold having a release layer for imprinting according to the embodiment is pressed against a resist layer on a transfer target substrate. (a) is a photograph of an example of the embodiment and (b) is a photograph of a comparative example.

FIG. 11 is a schematic diagram where (a) shows a schematic diagram for describing how a pattern size changes by providing a release layer in a comparative example, and (b) shows a schematic diagram for describing how the release layer is adsorbed or bonded to the mold in a case where a silane group is provided only on one end of a molecular chain in a comparative example.

### MODES FOR CARRYING OUT THE INVENTION

The present inventors have made various studies on a release layer that can suppress generating failures due to self aggregation, while maintaining imprint endurance. In the studies, the present inventors have focused on a fact that a modified silane group of the conventionally used silicone release agent facilitates the adhesion (that is, adsorbing or bonding) of a release layer to a mold but also causes the self aggregation thereof.

Then, the present inventors have focused on a relationship between the bonding energy that serves as the source of adsorption or bonding of the modified silane group (that is, the adsorption functional group for the mold) to the mold and the bonding energy between one adsorption functional group and another adsorption functional group during the self aggregation. Thus, the present inventors have found out that the self aggregation of the release agent compound, which is a problem in the imprinting, can be prevented if a bonding that causes adsorption or bonding of the adsorption functional groups to the mold is more stable than the bonding between one adsorption functional group and another adsorption functional group during the self aggregation.

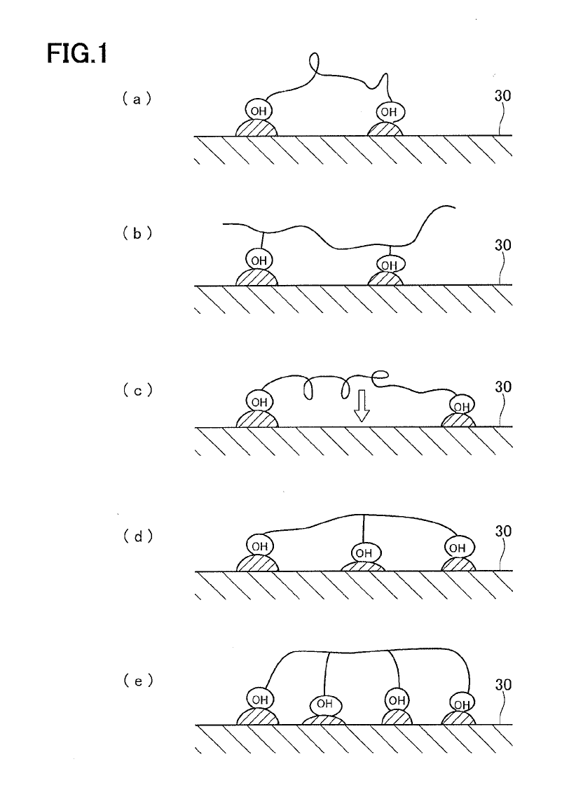

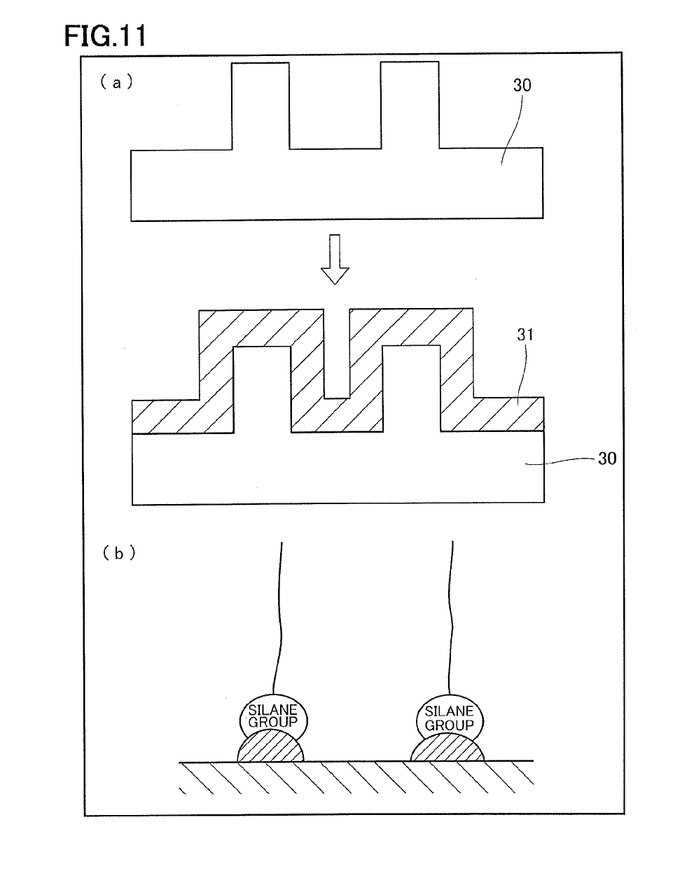

The present inventors have further focused on the fact that in the conventional case as shown in FIG. 11 (b), the modified silane group is provided only on one end of the release agent compound forming the release layer for imprinting. Thus, the present inventors have found out that a dimensional accuracy of the transferred pattern can be improved by providing a plurality of adsorption functional groups so that a thickness of the release layer does not depend on the entire length of a molecular chain of the release layer as shown in FIG. 1.

Furthermore, the present inventors have realized that, contrary to the conventional idea that surface free energy of the release layer on the mold should be low as much as possible, optimization of the surface free energy that appropriately raises the surface free energy in general is required to form a favorable pattern on the resist layer.

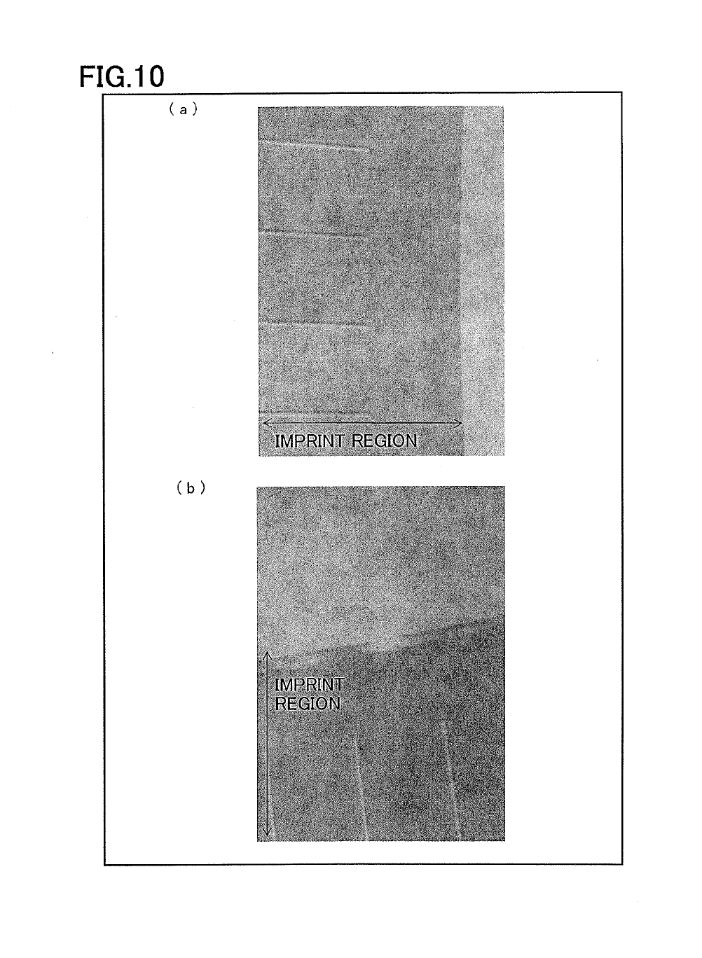

Specifically, the present inventors have found out that if a temperature for the heating after coating on with the release agent compound is raised or reduced in order to intentionally change the surface free energy of the release layer at a portion that comes in direct contact with the resist layer to be adjusted to an optimum surface free energy, a resist is favorably filled in recesses of the uneven pattern on the mold through the release layer for imprinting without failure (see FIG. 10 (a) related to an example described later).

### First Embodiment

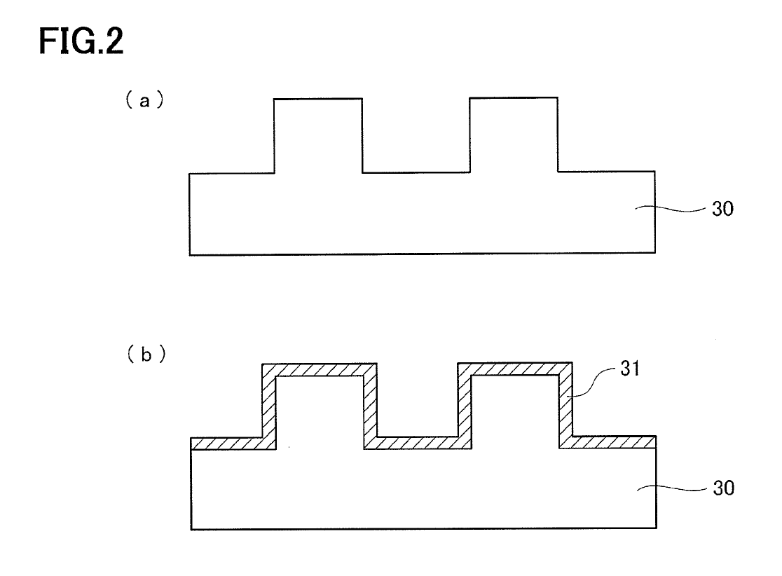

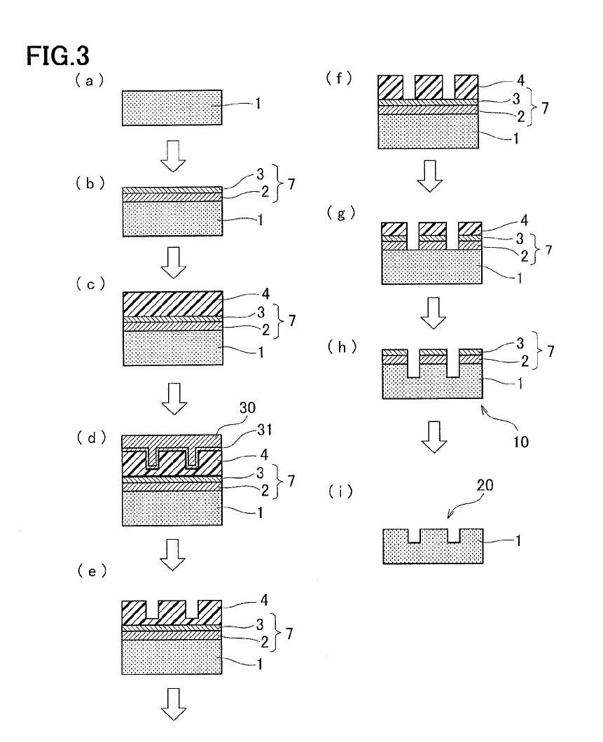

An embodiment of the present invention is described below. The description is given in the following order. First, a step of disposing a release layer on a mold is described with reference to FIG. 2, which is a schematic cross-sectional view. Then, a step of producing a copy mold 20 from a master mold as an original by optical nanoimprint technology is described with reference to FIG. 3, which is a schematic cross-sectional view.

It is a matter of course that, in a case where a pattern is transferred using the copy mold, the copy mold may be provided with the release layer. In the embodiment, the mold includes the master mold for imprinting and a primary copy mold reproduced by transferring using the master mold, as well as a higher copy mold including a secondary mold, a third mold, and so on reproduced thereafter.

(Preparing Mold)

First of all, a mold 30 that serves an original pattern for an uneven pattern to be transferred onto a copy mold 20 is prepared as shown in FIG. 2.

The mold 30 may be made of any materials that can be used for a mold for imprinting. Still, the material preferably has optical transparency (for example, quartz and the like if the exposure light is ultraviolet light) with respect to an exposure light that is used for an optical nanoimprinting method so that irradiation of the exposure light described later can be performed from a rear surface (that is, a side where a pattern is not formed) of the mold 30. If a substrate 1 with which a copy mold is produced has the optical transparency, the exposure can be performed from the side of the substrate (that is, a rear surface side where a pattern is not transferred and formed) for producing the copy mold. In this case, a material opaque with respect to the exposure light can be used for the mold 30 (for example, silicone wafer if the exposure light is ultraviolet light).

Instead of directly forming a release layer 31 on the mold substrate, the release layer 31 may be provided on a layer made of a different functional material that is formed on the mold 30.

In this embodiment, a case is described where a substrate made of quartz (also referred to as quartz substrate) having an unevenness corresponding to a prescribed uneven pattern is used for the mold 30.

While the prescribed uneven pattern formed on the quartz substrate may be of micrometer-scale order, in this embodiment, the pattern is of nanometer-scale order (for example, trench pattern having width of approximately 10 nm).

After the prescribed uneven pattern formed on the mold 30 is transferred by an imprinting method, the copy mold is provided with the uneven pattern which is inverted with respect to the prescribed uneven pattern. Thus, if the uneven pattern on the copy mold is the pattern to be ultimately formed, the mold 30 is provided with the uneven pattern inverted with respect to the uneven pattern to be ultimately formed. After transferring the uneven pattern on the primary copy mold, the transferring may be performed again using the uneven pattern on the primary copy mold to produce the secondary copy mold. The pattern that is the same as that on the mold 30 may be thus obtained.

(Disposing Release layer on Mold)

In this embodiment, the release layer 31 is formed by coating at least a portion of the mold 30 at which the prescribed uneven pattern is formed with a release agent compound, as shown in FIG. 2.

With the release layer 31, the mold 30 can be easily separated (released) at a low releasing pressure from a resist layer 4, after the resist layer 4 provided on the substrate 1 for producing the copy mold as shown FIG. 3, described later, is brought into contact with the mold 30 (through the release layer 31) in order to fill the resist 4 on the uneven pattern of the mold, and cured by exposure.

Thus, damages to the mold 30, damages to (defect of) the transferred pattern, or damages to the mold and the imprint apparatus due to a mold release failure or defect can be reduced.

The release layer 31 is described in detail below.

### (Overview of Structure of Release Agent Compound)

In the embodiment, a compound that forms the release layer is referred to as “release agent compound” or simply referred to as “compound”. The structure of the release agent compound of the present invention is described in detail below.

First of all, the release agent compound forming the release layer 31 according to this embodiment includes a main chain portion facilitating the releasing and adsorption functional groups for adsorbing or bonding to the mold 30.

(Main Chain Portion of Release Agent Compound)

A main chain of a molecular chain of the release agent compound contains fluorocarbon. Specifically, fluorine in the fluorocarbon reduces surface free energy of the release layer 31 that comes in direct contact with the resist layer 4 provided on the substrate 1 for producing a copy mold. Thus, the mold can be smoothly released at a low releasing pressure.

The fluorocarbon preferably includes one or a plurality of types of (CₘF₂ₘO)ₙ. With the main chain of the release agent compound thus containing a perfluoroether group, the molecular chain as a whole forms a random coil shape as shown in FIG. 1. Thus, the flexibility of the molecular chain can be improved. In the generally used conventional release agent compound including no ether group, the molecular chain is oriented in the thickness direction of the mold. Thus, the thickness of the release layer depends on the entire length of the molecular chain. In contrast, in the release agent compound used in the present invention, the flexibility of the molecular chain is improved and the molecular chain is less oriented in the thickness direction of the release layer 31. Accordingly, the release layer 31 can be thinner than in the conventional case.

Note that m is preferably an integer satisfying 1≦m≦7.

With m being 1 or more, appropriate flexibility can be obtained. Thus, molecular chains adsorbed on the mold 30 can be appropriately close to each other. Accordingly, with the appropriately closely-spaced molecular chains of fluorocarbon, surface free energy of the release layer 31 can be sufficiently reduced.

With m being 7 or less, appropriate rigidity is obtained. Thus, the case where a thickness of the layer depends on the entire length of the molecular chain can be avoided. For taking a balance between the adhesion and rigidity of such a molecular chain, m is particularly preferably 3 or 4.

Note that the value of n mentioned above is preferably an integer that makes a molecular weight of (CₘF₂ₘO)ₙ equal to or larger than 500 and equal to or smaller than 6000.

With the (CₘF₂ₘO)ₙ having the molecular weight equal to or larger than 500, self aggregation of the adsorption functional groups is not facilitated because of a short the molecular chain of the release agent compound. Moreover, an intermolecular force to be applied in directions to bring the molecular chains close to each other after adsorbing or bonding to the surface of the mold 30 can be maintained. Thus, with the appropriately closely-spaced molecular chains of fluorocarbon, the surface free energy of the release layer 31 can be sufficiently reduced.

With the molecular weight being equal to or smaller than 6000, the effect of reducing the thickness of the release layer 31 is not spoiled with the molecular chain being too long.

Specifically, the value of n is preferably 6 or 7.

(CₘF₂ₘO)ₙ may be a random copolymer or a block copolymer including a plurality of types. For example, (CₘF₂ₘO)ₙ may be a random copolymer of (CF₂O) and (C₂F₄O).

(Adsorption Functional Group of Release Agent Compound)

The release agent compound forming the release layer 31 includes at least two adsorption functional groups for the mold 30.

As described above, the release layer 31 is required to allow the mold to be smoothly released at a low releasing pressure from the resist layer 4 that is provided on the substrate for producing a copy mold. In addition, the release layer 31 is required to have imprint endurance for repeating the physical contact and releasing between the release layer 31 and the resist layer 4. In other words, a value of the surface free energy and the thickness of the release layer are required to be maintained. Specifically, the release layer 31 is required to have a sufficient adhesion to the mold 30. If the adhesion is insufficient, the release layer 31 may be detached from the mold to be attached onto the resist layer 4 in the imprinting. This might cause a degradation of the imprint endurance or a transfer defect that affects the pattern accuracy and the quality of the copy mold.

In this embodiment, a plurality of adsorption functional groups for the mold are provided. Thus, even if a single adsorption functional group cannot achieve strong adsorption, if each molecular chain in the release agent compound includes two or more adsorption functional groups, adsorbing point to the mold 30 can be provided at two or more positions in each molecular chain, and thus adhesion between the mold 30 and the release layer 31 can be improved.

In order to improve the adhesion between the mold 30 and the release layer 31, the adsorption functional groups are preferably provided respectively adjacent to both ends of the molecular chain of the release agent compound that forms the release layer 31 (FIG. 1 (b)), or more preferably, provided at both respective ends (FIG. 1 (a)). With the adsorption functional groups respectively provided at both ends or adjacent to both ends of the molecular chain, the molecular chain can be prevented from being approximately linearly oriented in the thickness direction of the release layer. Thus, the release layer can be much thinner than that in the conventional case. Furthermore, with the strong bonding to the mold 30 at two positions distant from each other in the molecular chain, the adhesion between the mold 30 and the release layer 31 can be improved.

The following effect can also be expected if the adsorption functional groups are respectively at portions close to both ends of the molecular chain of the release agent compound forming the release layer 31. Specifically, when the adsorption functional groups adsorb to the mold 30, the main chain is expected to form the random coil shape as described above. However, as shown in FIG. 1 (c), it is expected that with interaction such as the van der Waals force between the main chain and the mold 30, a physical force toward the mold 30 acts on the main chain.

When the adsorption functional groups are respectively provided adjacent to both ends of the molecular chain as described above, preferably, an adsorption functional group is further provided at a portion closer to the center of the molecular chain rather than the portions where the adsorption functional groups are provided as shown in FIG. 1 (d). This can increase the number of adsorbing points or the bonding points in the molecular chain of the release agent compound to the mold surface, which in turn allows the release layer to be even thinner. Considering a balance among the improvement of the adhesion, improvement of the mold releasability, and prevention of the self aggregation, the release agent compound preferably has three or four adsorption functional groups in total as shown in FIG. 1 (d) and FIG. 1 (e).

(Bonding Energy of Adsorption Functional Group)

In the present invention, a release agent compound is selected in which the bonding energy that is a source of adsorption of the adsorption functional groups to the mold is greater than the bonding energy between one adsorption functional group and another adsorption functional group in the molecular chain of the release agent compound. As described above, the self aggregation of the release agent compound causes degradation of the accuracy or a quality of the transferred pattern. However, since a compound that has a relationship of the bonding energy described above is used for the release agent compound, even when the self aggregation occurs among the adsorption functional groups, the self aggregation can be dissolved because the bonding energy between the surface of the mold 30 (including the substances (for example, water) naturally existing on the surface, hereinafter collectively referred to as surface) and the adsorption functional group is greater. Thus, the adsorption functional group is eventually adsorbed or bonded to the surface of the mold 30. Accordingly, the self aggregation of the release agent compound and the accompanying defect are suppressed, and thus the degradation of the accuracy and the quality of the transferred pattern can be suppressed.

The adsorption functional group is preferably a hydroxyl group, a carboxyl group, an ester group, or any combination of these, which is less likely to cause the self aggregation than the modified silane group. Although the adhesion (bonding energy) of a single adsorption functional group to the mold 30 is smaller than that of the modified silane group, in this embodiment, two or more adsorption functional groups are provided in each molecular chain as described above. Thus, a sufficient adhesion to the mold 30 can be secured. In terms of the bonding energy, that is, considering the improvement of the adhesion and the prevention of the self aggregation, the adsorption functional group is preferably the hydroxyl group.

As described above, the adsorption functional group adsorbs or bonds to the mold 30. If the adsorption functional group is a hydroxyl group, a carboxyl group, an ester group, or any combination of these, a strong bonding is expected to be achieved by dehydration synthesis between the water on the mold 30 and the adsorption functional group. If the mold 30 is a quartz substrate, hydrogen bonding occurs between the oxygen on the quartz substrate surface and the adsorption functional group. Thus, even higher adhesion between the mold 30 and the release layer 31 can be achieved.

(Additive)

The release layer formed by the release agent compound may contain a known material that can be added to the release agent, in addition to the compound described above.

(Coating Mold with Release Agent)

The mold 30 is coated with the release agent compound so that the release layer 31 is formed on the mold 30. An example of a method for the coating includes a dip method, spin coating, an ink jet technology, and a spraying method

When the dip method is employed, the dipping time is preferably 5 minutes or more. This allows the mold 30 to be sufficiently evenly coated with the release agent compound. Moreover, a time long enough for the adsorption functional group to adsorb to the mold 30 can be secured.

The dipped mold 30 is preferably pulled out at a speed of 80 to 200 mm/minute. The speed at or under the upper limit of the range would not impair the evenness of the coating of the release agent compound due to fluctuation of liquid level. The speed at or above the lower limit of the range can prevent reducing an amount of the pulled out liquid due to the meniscus force.

(Heating after Release Agent Compound is Coated On)

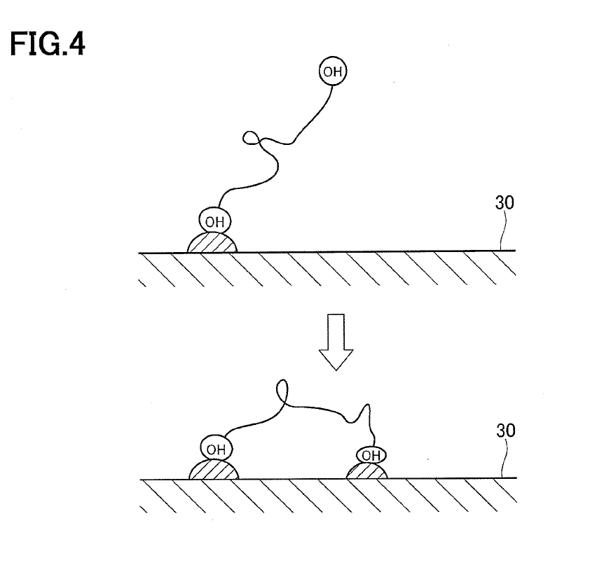

For example, after the mold 30 is coated with the release agent compound as described above, the mold 30 is heated at a temperature of 25° C. to 250° C. This is for removing the solvent in the release agent compound (solution) to densify the release layer 31 and improve the adhesion between the mold 30 and the release layer 31. Within the temperature range, the densification and the improvement of the adhesion of the release layer can be achieved without thermally decomposing the release agent compound. The heating within the temperature range can facilitate the adsorption or the bonding of two or more adsorption functional groups to the mold 30 as shown in FIG. 4. Furthermore, even higher adhesion between the mold 30 and the release layer 31 can be achieved, and the case where the thickness of the release layer depends on the entire length of the molecular chain of the release agent compound can be avoided.

An example of a specific heating means includes a clean oven and hot plate.

(Optimizing Surface Free Energy by Heating)

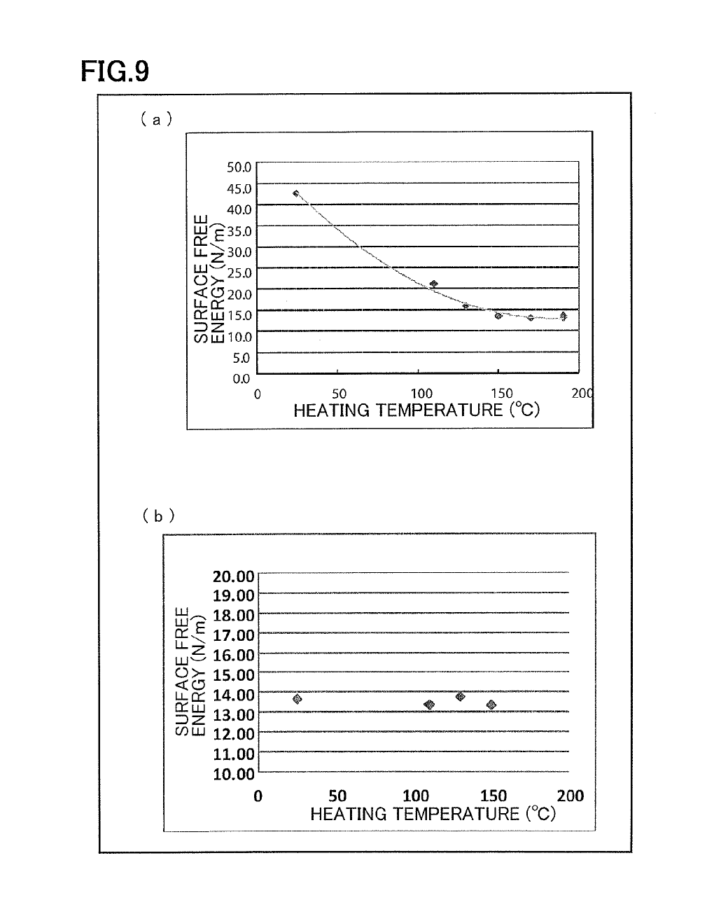

When the adsorption functional group of this embodiment is the hydroxyl group, with respect to the relationship (FIG. 9 (a)) between the heating temperature for the release agent compound and the surface free energy of the release layer of this embodiment, there are a region in which the surface free energy is unchanged even when the heating temperature is changed and a region in which the value of the surface free energy increases or decreases as the heating temperature changes (specifically, as the heating temperature decreases). The reduction of the surface free energy of the release layer that comes in direct contact with the resist layer might cause a problem that the resist 4 is not favorably or surely filled in the recesses of the uneven pattern on the mold. To address this, in this embodiment, the heating is performed so that the surface free energy of the release layer 31 can be optimized in accordance with the composition of the resist 4 so that the resist 4 is easily and surely filled in the fine uneven pattern on the mold 30.

Accordingly, the resist can be favorably and surely filled in the fine uneven pattern on the mold 30 whatever the composition of the resist 4 may be as long as the surface free energy of the release layer practically changes by heating and the like. Furthermore, there is even a possibility that filling speed of the resist 4 into the pattern on the mold 30 can be adjusted.

For thus appropriately increasing the surface free energy by the heating, the heating temperature is preferably adjusted and optimized in such a way that the release layer 31 after the heating can have desired surface free energy within the region in which the surface free energy increases as the heating temperature decreases. Specifically, the heating is preferably performed for the mold 30 coated with the release agent compound at a temperature equal to or higher than 25° C. and equal to or lower than 170° C.

Within this temperature range, by reducing the heating temperature from 170° C., excessively reduced surface free energy can be appropriately increased. Moreover, the resist 4 can be surely, favorably, and promptly filled in the fine uneven pattern on the mold through the release layer 31 in accordance with the composition of the used resist 4 without degrading the mold releasability.

Moreover, within this temperature range, the solvent of the release agent compound (solution) remaining in the release layer can be removed. Thus, the release layer 31 can be further densified and the adhesion between the mold 30 and the release layer 31 can be improved. Also, within the temperature range, the thickness of the mold release layer can be maintained without thermally decomposing the release agent compound, that is, the favorable mold releasability can be maintained.

(Rinsing)

After the heating as described above, the mold 30 on which the release layer 31 is formed is rinsed. This rinsing is performed for washing away the excess release agent compound neither adsorbed nor bonded to the surface of the mold 30.

In this embodiment, there is a point in performing the rinsing after the heating as described above. It is because when the rinsing is performed without performing the heating, the release agent compound not yet sufficiently adsorbed or bonded to the mold 30 is also washed away from the surface of the mold 30. In contrast, after the heating as described above, the release agent compound is adsorbed or bonded to the surface of the mold 30 as much as possible. In other words, by the heating (or in accordance with the temperature of the heating), the adsorption or bonding of the release agent compound to the mold is promoted. Thus, only the excess release agent compound neither adsorbed nor bonded to the surface of the mold 30 can be washed away with the rinsing after the heating. Thus, the surface energy can be prevented from increasing due to the excess release agent compound, the mold releasability is not degraded, and the thickness of the release layer is prevented from increasing. Moreover, reduction of the thickness of the release layer according to the number of imprinting times, fluctuation of the surface free energy, and the like are prevented, and thus the stable imprint endurance of the release layer 31 can be obtained. Any rinsing agent can be used as long as it does not dissolve the heated release layer 31.

The steps for forming the release layer 31 on the mold 30 are as described above.

Now, a method of producing a copy mold with an optical imprinting method using the mold 30 having the release layer 31 will be described with reference to FIG. 3.

(Preparing Substrate for Producing Copy Mold)

First, a substrate 1 for a copy mold 20 is prepared as shown in FIG. 3 (a).

The substrate 1 may be made of any material that can be used for the copy mold 20. For example, the material may be quartz, sapphire, silicon wafer, or the like. If the copy mold is to be used for an optical nanoimprinting method, the substrate 1 may be a quartz substrate that has transparency with respect to exposure light used in the optical nanoimprinting method.

The substrate 1 may have a disc shape (wafer shape), a rectangular shape, a polygonal shape, or a semicircular shape.

In this embodiment, a description is given with a quartz wafer having the same shape as the mold 30 as the substrate 1 for producing the copy mold 20.

(Forming Hard Mask Layer)

Next, the substrate 1 polished and washed as appropriate is introduced into a sputtering apparatus as shown in FIG. 3 (b). In this embodiment, a target including an alloy of tantalum (Ta) and hafnium (Hf) is sputtered with argon gas to form a conductive layer 2 made of a tantalum-hafnium alloy. Thus, a bottom layer (conductive layer 2) of a hard mask layer 7 is formed on the substrate 1.

The conductive layer 2 may be made of a known material used for a conductive layer. For example, a film composition with Ta as a primary component can be employed. Here, TaHf, TaZr, TaHfZr, or the like is preferably used. In this embodiment, the conductive layer 2 made of tantalum-hafnium (TaHf) is described.

For preventing oxidation of the conductive layer 2, no air exposure is performed, and subsequently a chrome (Cr) target is sputtered with a mixture gas of argon and nitride. Thus, a chromium nitride layer 3 is formed as an upper layer (anti-oxidation layer 3 for conductive layer) of the hard mask layer 7.

The anti-oxidation layer 3 is preferably made of chromium nitride (CrN) so that the sputtering for forming the layer needs not to involve oxygen. However, any other composition may be employed as long as the composition can be used for forming the anti-oxidation layer. For example, molybdenum, chromium oxide (CrO), SiC, amorphous carbon, and Al may be used. In this embodiment, the anti-oxidation layer 3 made of chromium nitride (CrN) is described.

As shown in FIG. 3 (b), the hard mask layer 7 having the tantalum-hafnium alloy layer 2 as the lower layer and the chromium nitride layer 3 as the upper layer is formed on the substrate 1.

The “hard mask layer” in this embodiment is not limited to the above combination. Any material, material property, and composition may be employed as long as the hard mask layer is made of one or a plurality of layers that can protect portions at which protrusions corresponding to the prescribed uneven pattern formed on the copy mold are to be formed on the substrate 1 (transfer target substrate), and can serve as an etching mask for recessing (forming recesses) on the substrate 1. The anti-oxidation layer 3 in the hard mask layer 7 may also serve as the conductive layer 2. In such a case, the conductive layer made of TaHf for example can be omitted.

The structure in which the hard mask layer 7 is formed on the substrate 1 is referred to as a blank for producing a copy mold in this embodiment.

(Forming Resist Layer)

After the blank for producing a copy mold is washed and subjected to dehydration baking as appropriate, the hard mask layer 7 is coated with a resist 4 for optical nanoimprinting as shown in FIG. 3 (c). If needed, heating may be performed thereafter as appropriate. The resist 4 for the optical nanoimprinting includes a light curing resin, and in particular, an ultraviolet curing resin. Any material, material property, and composition may be employed as long as the resist 4 is applicable to the employed imprinting method, and suitable for the etching step carried out later, that is, as long as sufficient etching selectivity for the hard mask layer is provided.

The thickness of the resist layer 4 is preferably equal to or larger than the thickness with which the resist layer 4 remains until the various etchings are completed at portions serving as the mask (portions to be protrusions on the copy mold).

Before disposing the resist layer 4, an adhesion promoting layer may be formed on the hard mask layer 7. With the adhesion promoting layer, the pattern deficit due to the resist layer 4 detaching in the imprinting step and the etching step can be prevented.

(Pattern Transfer by Nanoimprinting Method)

Next, as shown in FIG. 3 (d), the mold 30 on which the fine uneven pattern and the release layer 31 are formed is placed on the resist layer 4. The mold 30 is placed until the resist 4 completely fills the uneven pattern.

Here, if the resist layer 4 is approximately in a liquid form, the mold 30 only needs to be placed still on the resist layer 4 and needs not to be pressed strongly. If the resist layer 4 is approximately in a solid form, the mold 30 is relatively strongly pressed against the resist layer 4, and then the mold 30 is placed still until the resist layer 4 completely fills the uneven pattern of the mold 30.

Then, while maintaining the adhered state between the mold 30 and the resist layer 4 (that is, quartz wafer for producing a copy mold), the exposure using a UV radiation apparatus is performed to cure the resist layer 4. Here, the UV ray is generally irradiated from the rear surface (that is, the side where pattern is not formed) of the mold 30. However, if the substrate 1 has optical transparency with respect to the exposure light, the irradiation may be performed from the side of the substrate 1.

In this case, a trench and the like as an alignment mark may be provided on any one of the mold 30 and the transfer target substrate or both to prevent transfer failure due to misalignment between the mold 30 and the substrate 1.

The resist 4 filled in the fine uneven pattern on the mold 30 is cured by the exposure, and thus the fine uneven pattern is formed on the resist layer 4.

After the exposure, the mold 30 and the resist 4 are separated. As shown in FIG. 3 (e), the mold is released and the fine pattern transferred and formed on the resist 4 is exposed.

(Removing Remaining Layer of Resist Layer)

After the fine pattern is transferred and formed on the resist layer 4, the remaining layers of the resist in the recessed portions of the fine uneven pattern that is formed on the resist layer 4 on the chromium nitride layer 3 are removed by ashing using plasma of oxygen, argon, fluorine-based gas, or mixture gas of these. Thus, the resist pattern corresponding to the desired fine uneven pattern is formed as shown in FIG. 3 (f). Trenches are to be formed on the substrate 1 at the recesses of the fine uneven pattern transferred and formed on the resist layer 4.

(First Etching)

Next, the substrate 1 provided with the resist pattern on the surface is introduced into a dry-etching apparatus. Then, a first etching is performed with gas including chlorine gas in an atmosphere substantially excluding oxygen gas. Here, reducing gas is preferably used in the etching using the gas for preventing oxidation of the conductive layer 2.

“Atmosphere substantially excluding oxygen gas” indicates “atmosphere in which even when oxygen gas flows in during the etching, the amount of the oxygen gas flown in is small enough to allow performing anisotropic etching”. In the atmosphere, the amount of the oxygen gas flown in is preferably equal to or smaller than 5% of the amount of entire gas flown in.

By the etching, the hard mask layer 7 on which the fine pattern is formed with the resist pattern as an original pattern is obtained as shown in FIG. 3 (g). The end point of the etching is determined with, for example, an endpoint detector of a catoptric type or the like.

(Second Etching)

Next, the gas used in the first etching is exhausted from an etching chamber, and then in the same dry etching apparatus, a second etching using fluorine-based gas is performed on the substrate 1 having the hard mask layer 7 with fine pattern. Here, the substrate 1 made of quartz is etched with the hard mask layer 7 serving as a mask so that the substrate 1 is provided with trenches corresponding to the fine pattern as shown in FIG. 3 (h). The resist layer is removed by an alkaline solution or an acid solution before or after the etching.

The fluorine-based gas used herein may be CₓF_{y}, (for example, CF₄, C₂F₆, or C₃F₈), CHF₃, mixture gas of these, or any of these containing a noble gas (He, Ar, Xe, or the like) as added gas.

Thus, as shown in FIG. 3 (h), the substrate 1 made of quartz is provided with trenches corresponding to the fine pattern, and the hard mask layer 7 having the fine pattern remains on the portion other than the trenches on the substrate 1 made of quartz. Thus, a mold 10 that has a remaining hard mask layer 7 is obtained.

(Removing Hard Mask Layer)

The mold 10 that has the remaining hard mask layer 7 produced as described above is then subjected to the step of removing the hard mask layer 7 remaining on mold 10 by dry etching with a method similar to that in the first etching. Thus, an imprint mold 20 that is provided with the fine uneven pattern on the surface of the substrate 1 made of quartz, is produced (FIG. 3 (i)).

It is noted that any one of the etchings may be wet etching and the other one of the etchings may be dry etching. Alternatively, both etchings may be wet etching or dry etching. Any combination of wet etching and dry etching can be employed as long as the desired fine uneven pattern can be formed.

In this embodiment, the etchings described above are performed. Instead, an etching may be additionally performed between the first and the second etchings, or before the first etching or after the second etching depending on forming materials of a blank for producing a copy mold.

(Completing Copy Mold)

After the steps described above, the washing of the substrate 1 and the like is performed if needed. Thus, the copy mold 20 as shown in FIG. 3 (i) is completed.

(Restoring Mold)

In order to newly produce a copy mold, the mold 30 after performing the imprinting is subjected to restoring processing. Specifically, the mold 30 is washed by sulfuric acid hydrogen peroxide mixture or the like to remove the release layer 31. Then, washing, drying, and the like are performed as appropriate. Thereafter, the mold 30 is coated with the release agent again so that the release layer 31 is formed thereon.

### Second Embodiment

In the first embodiment described above, the copy mold 20 to be produced from the master mold for optical imprinting is described.

On the other hand, in this embodiment, the copy mold 20 to be produced from a master mold for thermal imprinting will be described. Note that portions not particularly mentioned in the following description are similar to those in the first embodiment.

To begin with, as a substrate used for producing the copy mold 20 from the master mold for thermal imprinting, a SiC substrate can be used. The SiC substrate has resistance against chlorine gas used in dry etching on the hard mask layer 7.

Other than the SiC substrate having resistance against chlorine gas, a silicon wafer that has a relatively low resistance against the chlorine gas can also be used for the substrate 1 for thermal imprinting, by giving the following treatment. Namely, a SiO₂ layer is first disposed on the silicone wafer 1. Then, the hard mask layer 7 is disposed on the SiO2₂ layer. Thus, even when the hard mask layer 7 is removed by the chlorine gas, the SiO₂ layer protects the silicon wafer from the chlorine gas. Then, the SiO₂ layer is removed by buffered hydrofluoric acid, that is a mixed acid of ammonium fluoride and hydrofluoric acid. With such a treatment, the silicon wafer can be used for producing the mold for the thermal imprinting. A silicon wafer provided with the SiO₂ layer as a processed layer can also be used as the substrate. Here, trenches are formed on the SiO₂ layer as the processed layer. Thus, the SiO₂ layer is preferably thicker than that in the case where the silicone wafer 1 is used.

In this embodiment, the description is given with a disk-shaped SiC substrate.

In this embodiment, the conductive layer 2 made of TaHf and the chromium nitride layer 3 is formed on the substrate 1.

Next, the hard mask layer 7 of the blank is coated with a resist for thermal imprinting to form the resist layer 4. Thus, the blank having the resist to be used for producing the copy mold 20 in this embodiment is prepared. The resist for thermal imprinting includes thermoplastic resins that are cured when cooled. Any kind of the thermoplastic resins may be used as long as it is suitable for the etching step performed later. The resin is preferably soft enough to allow the fine pattern for transferring to be formed when the mold as an original pattern is pressed against the resist in the heating. Thus, when the mold is pressed against the resist, the resist easily deforms in accordance with the fine pattern on the mold 30 and the release layer 31. Accordingly, the fine pattern can be accurately transferred.

Then, the substrate 1, more specifically, the resist layer 4, is cooled. Thus, the fine pattern of the mold 30 is transferred on the resist layer 4.

After the fine pattern is transferred, the remaining layer of the resist on the hard mask layer 7 is removed by ashing. Then, through the steps described in the first embodiment, the copy mold 20 of the master mold for imprinting is completed.

The embodiments according to the present invention are described above. The content of the disclosure above describes exemplarily embodiments of the present invention, and the scope of the present invention is not limited to the above described exemplarily embodiments. A person skilled in the art can implement the embodiments of the present invention while making various modification thereon based on the content disclosed in this specification, regardless of whether it is explicitly described or indicated in this specification.

(Effects of the Embodiments)

The following effects can be obtained by the embodiment described above.

To begin with, fluorine in the fluorocarbon that forms the release layer can reduce surface energy of a portion in contact with the resist layer provided on the substrate for producing a copy mold. Thus, the mold can be released from the transfer target substrate smoothly at a low releasing pressure.

Furthermore, a plurality of adsorption functional groups for the mold are provided, and thus adsorption or bonding can be made at two positions of each molecular chain. Accordingly, adhesion between the mold and the release layer can be improved.

In addition, in the adsorption functional groups, the bonding energy that is a source of the adsorption or bonding of the adsorption functional groups, to the mold is greater than the bonding energy between one adsorption functional group and another adsorption functional group in the molecular chain of the release agentcompound. Thus, self aggregation of the release agent compound can be prevented, and also the adhesion between the mold and the release layer can be improved.

With a release agent compound that is capable of changing the surface free energy appropriately by changing the heating temperature of the release layer, the resist can be favorably and surely filled in the mold without degrading the mold releasbility. Thus, transfer pattern defects due to filling failure can be reduced. Thus, the pattern can be accurately transferred in the imprinting, which in turn results in the improvement of the accuracy and the quality of the transfer target (for example, copy mold), and further to the improvement of the quality of the final product to be obtained by the transfer target.

The copy mold made of quartz and produced using the optical imprinting as described above can be used for any of thermal imprinting, room temperature imprinting, and optical imprinting. This embodiment can be preferably applied, especially, to a patterned medium that is produced by means of the optical nanoimprint technology.

### Example

Next, an example will be described for more concrete description of the present invention. It is a matter of course that the present invention is not limited to the example described below.

### Example

In this example, a mold 30 formed of a quartz substrate having a periodic structure with a depth of 30 nm, a depth at the recess (groove) of 15 nm, a depth at the protrusion (protruding portion) of 35 nm, and a pitch of 50 nm.

The mold 30 is dipped in a release agent compound for 5 minutes. The release agent compound includes the following compound (molecular weight of (C₃F₆O)ₙ is equal to or larger than 500 and equal to or smaller than 6000) diluted to 0.5 wt % with VERTREL XF-UP (manufactured by Du Pont-Mitsui Fluorochemicals Co., Ltd, VERTREL is a registered trade mark).

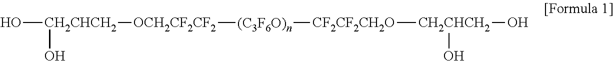

Then, the mold 30 was pulled out from the solution of the release agent compound at a speed of 120 mm/min. The release agent compound was coated on through such a dip method.

Here, a plurality of samples were prepared and were each subjected to the heating at a temperature of 25 to 205 after being pulled out. Then, the mold 30 was rinsed. The rinsing was performed by 10 minutes dipping again in the VERTREL XF-UP, using as the rinsing agent.

Thus, the mold having a release layer for imprinting according to the example was obtained.

Thereafter, a wafer-shaped synthetic quartz substrate (having outer diameter of 150 mm and thickness of 0.7 mm, hereinafter referred to as quartz wafer 1) was used as the substrate 1 for producing the copy mold 20 in this example (FIG. 3 (a)).

Next, the quartz wafer 1 was introduced into a sputtering apparatus. Then, a target including tantalum (Ta) and hafnium (Hf) (atomic ratio of Ta:Hf=80:20) was sputtered with argon gas. Thus, the conductive layer 2 made of tantalum-hafnium alloy and having a thickness of 7 nm was formed on the quartz wafer 1.

Next, a chromium target was sputtered with mixture gas of argon and nitride to form the chromium nitride layer 3 having a thickness of 2.5 nm (FIG. 3 (b)). Thus, the hard mask layer 7 including the conductive layer 2 and the chromium nitride layer 3 was formed on the quartz wafer 1.

Next, an adhesion promoting agent was coated on the hard mask layer 7 formed on the quartz wafer 1 by spin coating. Specifically, the quartz wafer 1 on which the adhesion promoting agent was dropped was rotated at a rotation speed of 3000 rmp for 60 seconds. The quartz wafer 1 coated with the adhesion promoting agent was heated with a hot plate at 160° C. for 60 seconds.

Then, an ultraviolet curing resist 4 (PAK-01 manufactured by Toyo Gosei CO. Ltd) for optical nanoimprinting was coated on also by the spin coating to form the resist layer 4 having a thickness of 45 nm (FIG. 3 (c)).

Next, a nonoimprint apparatus (Imprio-1100TR manufactured by Molecular Imprints, Inc.) was used. Specifically, the mold 30 was placed on the quartz wafer 1 which was coated with the ultraviolet curing resist layer 4 for 30 seconds so that the uneven pattern on the mold 30 was filled with the resist 4. Then, the resist 4 was cured by UV-exposure for 20 seconds (FIG. 3 (d)). Thereafter, releasing was performed by separating the mold 30 from the quartz wafer 1. Thus, the fine uneven pattern on the mold 30 was transferred on the resist layer 4 (FIG. 3 (e)).

Then, a remaining layer of the resist layer 4, on which the uneven pattern was transferred, on the hard mask layer 7 were removed by ashing using plasma of oxygen and argon gas. Thus, the hard mask layer 7 corresponding to the recesses of the desired fine uneven pattern was exposed (FGI. 3 (f)).

Next, the quartz wafer 1 with the hard mask layer 7 that has a resist pattern formed by removing the remaining layers was introduced into a dry etching apparatus. The dry etching was performed by simultaneously introducing Cl₂ gas and Ar gas. Thus, the hard mask layer 7 having the fine pattern was formed (FIG. 3 (g)).

Subsequently, the gas used for the dry etching on the hard mask layer 7 was evacuated. Thereafter, in the same dry etching apparatus, the quartz wafer 1 was subjected to dry etching using fluorine-based gas (CHF₃:Ar=1:9 (flow ratio)). Here, the quartz wafer 1 was etched using the hard mask layer 7 as a mask which has the fine pattern formed by using the resist pattern as the original pattern. Thus, the quartz wafer 1 was provided with trenches corresponding to the fine uneven pattern (the uneven pattern is inversed with respect to that of the mold 30).

Then, the resist layer 4 was removed with sulfuric acid hydrogen peroxide mixture including concentrated sulfuric acid and hydrogen peroxide solution (volume ratio of concentrated sulfuric acid:hydrogen peroxide solution=2:1). Thus, a mold 10 that has a remaining hard mask layer 7 for producing the copy mold 20 of the example was obtained (FIG. 3 (h)).

Thereafter, the mold 10 that has the remaining hard mask layer 7 was introduced into the dry etching apparatus that was used for etching the hard mask layer 7. Then, the hard mask layer 7 on the substrate was removed. Finally, washing was performed as appropriate. Thus, the copy mold 20 of the example, that is, the copy mold formed of the quartz wafer having the uneven pattern corresponding to the fine uneven pattern on the mold 30 (the uneven pattern is inversed) was produced (FIG. 3 (i)).

### Comparative Example

To be compared with the example described above, in a comparative example, a compound containing a modified silane group (product name: OPTOOL (registered trademark) manufactured by Daikin Industries, Ltd) was used as the release agent compound. The mold 30 coated with the release agent was heated at a temperature of 25° C. to 190° C. A mold with a release layer and a copy mold were produced with procedures similar to those in the example except the above.

<Evaluation>

### (1. Surface Roughness of Mold Having Release Layer)

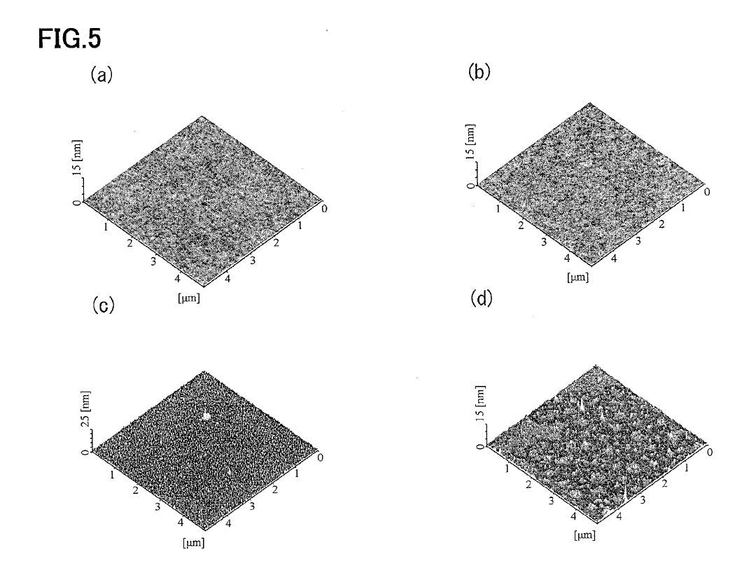

Surface roughness was measured with an atomic force microscope for the mold having the release layer obtained by each of the examples and the comparative example. FIG. 5 shows the results. FIG. 5 (a) and FIG. 5 (b) are measurement results showing surfaces of the mold having a release layer of the example, in which FIG. 5 (a) is the measurement result showing the surface of the mold having a release layer before imprinting, and FIG. 5 (b) is the measurement result showing the surface of the mold having a release layer after single imprinting. FIG. 5 (c) and FIG. 5 (d) are measurement results showing surfaces of the mold having a release layer of the comparative example, in which FIG. 5 (c) is the measurement result showing the surface of the mold having a release layer before imprinting, and FIG. 5 (d) is the measurement result showing the surface of the mold having a release layer after single imprinting.

In the example, no defect due to self aggregation was found before and after the imprinting as shown in FIG. 5 (a) and FIG. 5 (b).

On the other hand, in the comparative example, a plurality of defects due to self aggregation were found as shown in FIG. 5 (c) and FIG. 5 (d). Furthermore, a number of defects were generated after the imprinting.

### (2. Imprint Endurance)

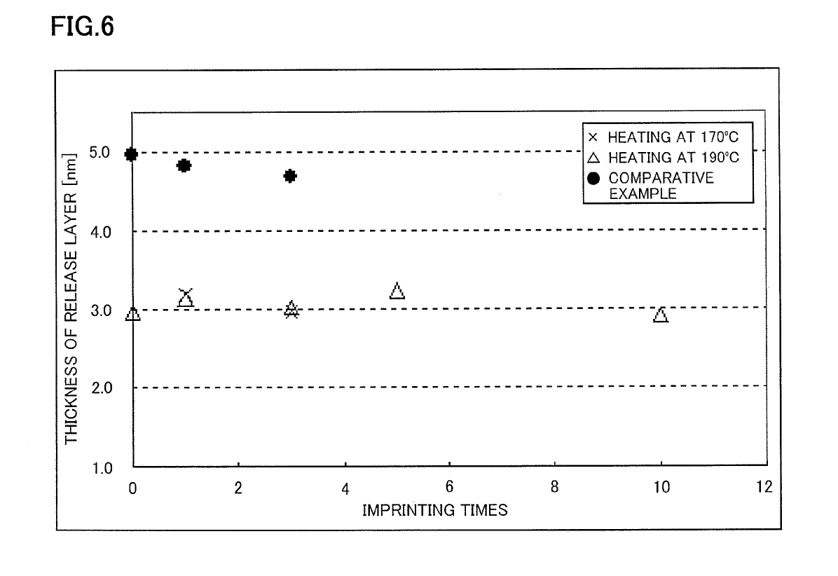

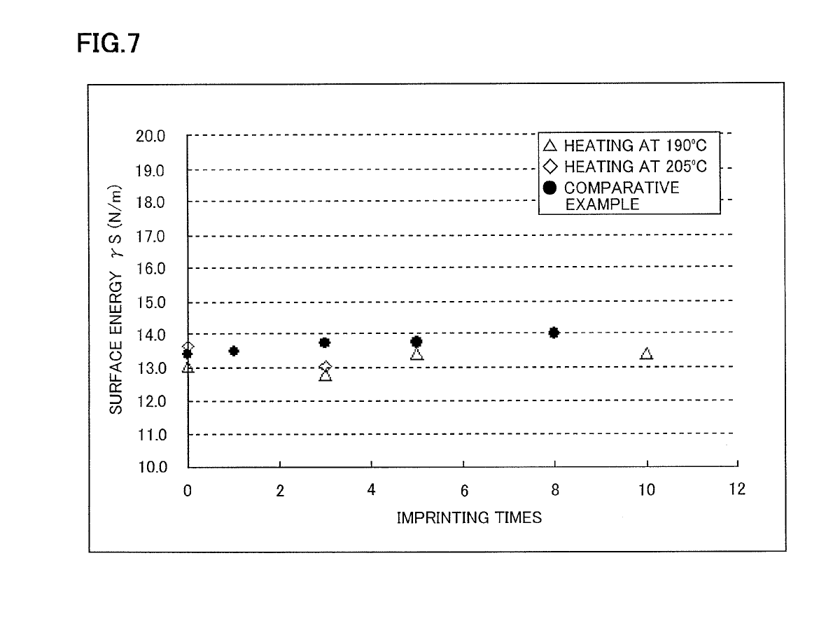

The imprint endurance of the mold having a release layer according to each of the examples and the comparative example was also examined. From FIG. 6 that shows the examining results (change of the thickness of the release layer against the number of imprinting times), it was found that the thickness of the release layer was maintained in the example. On the other hand, in the comparative example, the release layer became thinner as the number of imprinting times was increased. In addition, as shown in FIG. 7 (surface free energy of a release layer), the surface free energy was maintained at a low level even after the imprinting was performed for a plurality of times.

### (3. Thickness of Release Layer)

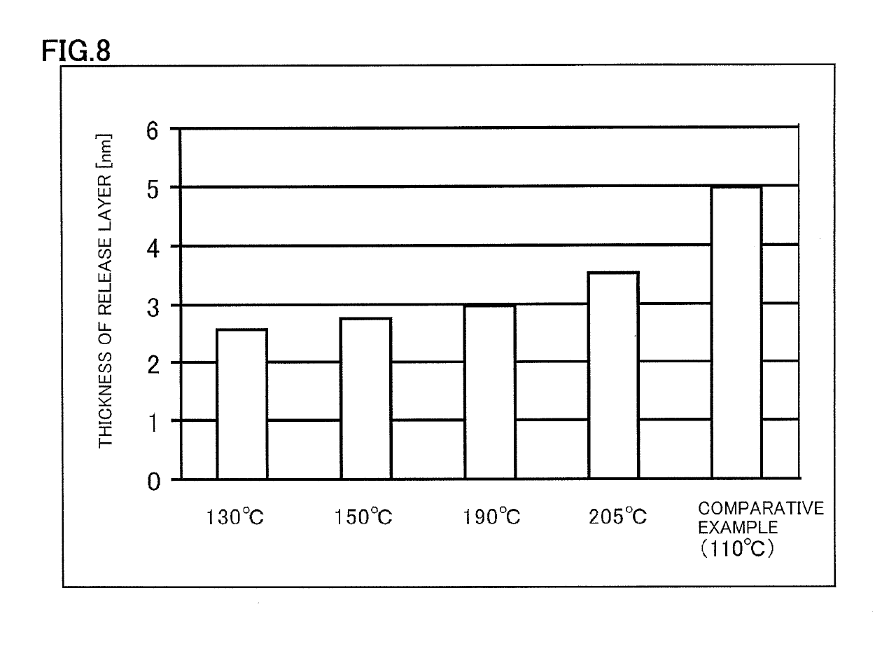

Thicknesses of the release layer of the mold having a release layer according to each of the example and the comparative example were also examined. From FIG. 8 that shows the examining result, it was found that thinner release layers were obtained in the example (130° C., 150° C., 190° C., and 205° C.) compared with the comparative example (110° C.).

### (4. Optimizing Surface Free Energy by Heating)

Furthermore, a relationship between the heating temperature and the surface free energy was examined. FIG. 9 (a) (example) and FIG. 9 (b) (comparative example) show the results.

In the example, as shown in FIG. 9 (a), the surface free energy was practically unchanged with the heating temperature exceeding 170° C. On the other hand, the surface free energy was able to be changed by changing the heating temperature as long as the temperature was at or below 170° C. It has been found out that adjusting and optimizing the surface free energy in accordance with a composition of the resist 4 can facilitate sure filling of the resist 4 into the mold 30 with the release layer 31 without filling failure.

On the other hand, in the comparative example, as shown in FIG. 9 (b), the surface free energy was practically unchangeable even when the heating is changed. Thus, the surface free energy of the release layer 31 was not able to be optimized in accordance with the composition of the resist 4.

### (5. Favorable Filling)

With the optical imprint apparatus, the mold having the release layer obtained by each of the examples and the comparative example was brought into contact with the resist layer 4 made of ultraviolet curing resin on the quartz wafer 1 on which the hard mask layer is formed. FIG. 10 (a) (example) and FIG. 10 (b) (comparative example) show photographs in this case.

This mold having the release layer is a sample which was subjected to the heating at 170° C. after the release agent compound was coated.

In the example, as can be seen in FIG. 10 (a), the resist 4 was able to be surely filled over the entire mold 30 without filling failure.

On the other hand, in the comparative example, as can be seen in FIG. 10 (b), filling failure was generated at a region extending from a center portion of each of the left and right sides toward a lower portion of mold 30.

### DESCRIPTION OF THE REFERENCE NUMERAL

1 Substrate
2 Conductive layer
3 Chromium nitride layer
4 Resist layer
7 Hard mask layer
10 Mold that has a remaining hard mask layer
20 Copy mold
30 Mold
31 Release layer for imprinting

1. A mold having a release layer, the mold being used for transferring a prescribed uneven pattern onto a material to be patterned by means of an imprinting method,
wherein a main chain of a release agent compound that forms the release layer comprises a fluorocarbon,
wherein the release agent compound comprises at least two adsorption functional groups adsorbed or bonded to the mold, and
wherein bonding energy between the adsorption functional groups and the mold is greater than the bonding energy between the adsorption functional groups in a molecular chain of the release agent compound.

2. The mold having the release layer according to claim 1,
wherein the adsorption functional groups comprise functional groups capable of forming hydrogen bonding to the mold.

3. The mold having the release layer according to claim 1,
wherein the adsorption functional groups comprise any one of a hydroxyl group, a carboxyl group, an ester group, and any combination of these.

4. The mold having the release layer according to claim 1,
wherein the adsorption functional groups are respectively provided at both ends of the molecular chain of the release agent compound that forms the release layer.

5. The mold having the release layer according to claim 1,
wherein the molecular chain of the release agent compound that forms the release layer comprises no side chain.

6. The mold having the release layer according to claim 1,
wherein the fluorocarbon comprises one or a plurality of types of (CₘF₂ₘO)ₙ, where m is an integer satisfying 1≦m≦7 and n is an integer that makes a molecular weight of the (CₘF₂ₘO)ₙ equal to or larger than 500 and equal to or smaller than 6000.

7. The mold having the release layer according to claim 1,
wherein, with respect to a relationship between a heating temperature for the release layer and surface free energy of the release layer, the release layer comprises a region in which a value of the surface free energy is unchanged even when the heating temperature is changed and a region in which the value of the surface free energy increases or decreases as the heating temperature decreases or increases, and the release layer after the heating comprises a region in which the value of the surface free energy increases as the heating temperature decreases.

8. The mold having the release layer according to claim 1,
wherein the mold comprises a quartz substrate comprising an uneven pattern corresponding to the prescribed pattern.

9. A mold having a release layer, the mold being used for transferring a prescribed uneven pattern onto a material to be patterned by means of an imprinting method,
wherein a main chain in a molecular chain of a release agent compound that forms the release layer comprises one or a plurality of types of (CₘF₂ₘO)ₙ, where m is an integer satisfying 1≦m≦7 and n is an integer that makes a molecular weight of the (CₘF₂ₘO)ₙ equal to or larger than 500 and equal to or smaller than 6000,
wherein the release agent compound comprises at least two hydroxyl groups as adsorption functional groups for the mold, the hydroxyl groups being respectively provided at both ends of the release agent compound, and
wherein with respect to a relationship between a heating temperature for the release layer and surface free energy of the release layer, the release layer comprises a region in which a value of the surface free energy is substantially unchanged even when the heating temperature is changed and a region in which the surface free energy increases and decreases as the heating temperature decreases and increases, and the release layer after the heating comprises a region in which the value of the surface free energy increases as the heating temperature decreases.

10. A method for producing the mold having the release layer according to claim 1,
wherein the method comprises optimizing surface energy of the release layer by changing surface free energy of the release layer by means of heating after the mold is coated with the release agent compound.

11. The method for producing the mold having the release layer according to claim 10,
wherein the heating is performed at a temperature equal to or higher than 25° C. and equal to or lower than 250° C.

12. The method for producing the mold having the release layer according to claim 10, further comprising rinsing the release layer after the heating.

13. A method for producing a copy mold from the mold having the release layer according to claim 1, the method comprising:
disposing the release layer in the mold;
forming a hard mask layer on a substrate for producing the copy mold;
forming a resist layer on the hard mask layer;
transferring a pattern of the mold onto the resist layer;
etching the hard mask layer using the resist layer as a mask, on which the pattern of the mold is transferred; and
etching the substrate for producing the copy mold using the hard mask layer as a mask, which is etched using the resist layer as the mask.
